(19) United States
(12) Patent Application Publication
(10) Pub. No.: US 2022/0118629 A1
(43) Pub. Date: Apr. 21, 2022

(54) Hybrid robotic picking device

(71) Applicants: Nicholas Payton, Somerville, MA (US); Lael Odhner, Medford, MA (US); Patrick Dingle, Cambridge, MA (US)

(72) Inventors: Nicholas Payton, Somerville, MA (US); Lael Odhner, Medford, MA (US); Patrick Dingle, Cambridge, MA (US)

(21) Appl. No.: 17/281,681

(22) PCT Filed: Oct. 3, 2019
(86) PCT No.: PCT/US2019/054558

§ 371 Date: Jun. 30, 2021

Related U.S. Application Data
(60) Provisional application No. 62/740,763, filed on Oct. 3, 2018.
(60) Provisional application No. 62/818,363, filed on Mar. 14, 2019.

(51) Int. Cl. B25J 15/00; B25J 15/06; B25J 15/02

(52) U.S. Cl. CPC B25J 15/0066; B65G 47/918; B25J 15/0206; B25J 15/0658

(57) ABSTRACT

Robotic picking devices and methods for performing a picking operation. The robotic picking device includes a suction device configured to obtain an initial grasp on an item, and at least one finger portion configured to stabilize the item upon the suction device obtaining the initial grasp on the item.

### CROSS-REFERENCE TO RELATED APPLICATIONS

The present application claims the benefit of and priority to co-pending U.S. provisional application No. 62/740,763, filed on Oct. 3, 2018, and co-pending U.S. provisional application No. 62/818,363, filed on Mar. 14, 2019, the entire disclosures of each of which are incorporated by reference as if set forth in their entirety herein.

### TECHNICAL FIELD

Embodiments described herein generally relate to robotic devices and methods and, more particularly but not exclusively, to robotic devices and methods for performing picking operations.

### BACKGROUND

Logistic operations such as those in warehouse environments often include robotic picking devices to gather items from a first location (e.g., a container) and place the items at a second location (e.g., on a conveyor belt). These robotic solutions are typically tailored to a very narrow class of pick items.

For example, a particular picking device may be configured to only grip items that have a particular size, shape, weight, material, surface, etc. Accordingly, this limits a single picking device's value in picking operations that involve different types of items.

Manufacturers attempt to overcome or otherwise mitigate these limitations by enabling end users to modify their picking device(s). For example, manufacturers may provide a degree of modularity by configuring an actuator to receive different sized or shaped fingers. Accordingly, this enables an end user to customize a standard picking device to match a particular item set.

However, these reconfiguration processes are usually manual processes. These processes therefore consume time and resources. Additionally, the exchange of parts also requires the picking devices to be temporarily taken out of service, thereby increasing downtime.

Even with these customization abilities, some items may nonetheless be difficult to grasp due to their small size. For example, small items have small suction sites that limit the number and size of suction cups that can be used (if the robotic picking device relies on suction-based techniques for grasping the items).

Larger or heavier items, on the other hand, tend to swing and possibly detach from suction device(s) if moved quickly. If suction-based grippers are used, these larger or heavier items may require large suction cups and/or multiple, widely-spaced suction sites. This limits the range of items that a particular suction-based picking device can handle.

A need exists, therefore, for robotic devices and methods that overcome the disadvantages of existing techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a method of performing a picking operation. The method includes positioning a robotic picking device with respect to an item to be picked, wherein the robotic picking device includes a suction device and at least one finger portion; operating the suction device to generate a suction force on the item to obtain an initial grasp on the item; and actuating the at least one finger portion to stabilize the item.

In some embodiments, the suction device is operably connected to a linear extension member, and the method further includes extending the linear extension member to at least assist in obtaining the initial grasp on the item. In some embodiments, the method further includes retracting the linear extension member after the suction device has obtained the initial grasp on the item. In some embodiments, the linear extension member is driven by a motor and includes a vacuum line therein. In some embodiments, the linear extension member is configured with at least one of fluted portions, keyed portions, squared portions, and a non-circular exterior to prevent rotation of the linear extension member. In some embodiments, the linear extension member is configured with a sliding seal to prevent leakage of the suction force.

In some embodiments, actuating the at least one finger portion to stabilize the item includes closing at least three finger portions to contact the item to stabilize the item. In some embodiments, the at least three finger portions are positioned about the suction device. In some embodiments, each of the at least three finger portions are positioned to not intersect with each other when the finger portions are actuated.

In some embodiments, the at least one finger portion is actuated to stabilize the item after the suction device has obtained the initial grasp on the item.

In some embodiments, operating the suction device includes routing air flow through milled slots in a manifold assembly in operable connectivity with the suction device.

In some embodiments, the method further includes generating an exhaust force to release the item from the suction device.

According to another aspect, embodiments relate to a robotic picking device for performing a picking operation. The picking device includes a suction device configured to generate a suction force on an item to be picked to obtain an initial grasp on the item and at least one finger portion configured to stabilize the item upon the suction device obtaining the initial grasp on the item.

In some embodiments, the picking device further includes a linear extension member configured to extend the suction device to at least assist in obtaining the initial grasp on the item. In some embodiments, the linear extension member is further configured to be retracted after the suction device has obtained the initial grasp on the item. In some embodiments, the linear extension member is driven by a motor and includes a vacuum line therein. In some embodiments, the linear extension member is configured with at least one of fluted portions, keyed portions, squared portions, and a non-circular exterior to prevent rotation of the linear extension member. In some embodiments, the picking device further includes a sliding seal configured with the linear extension member to prevent leakage of the suction force.

In some embodiments, the at least one finger portion includes three finger portions to contact the item to stabilize the item. In some embodiments, the finger portions are positioned about the suction device. In some embodiments, each of the at least three finger portions are positioned to not intersect with each other when the finger portions are actuated.

In some embodiments, the at least one finger portion stabilizes the item after the suction device has obtained the initial grasp on the item.

In some embodiments, the picking device further includes a manifold assembly, wherein the generated suction force is routed through milled slots in the manifold assembly.

In some embodiments, the suction device is further configured to generate an exhaust force to release the item from the suction device.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified.

FIG. 1 illustrates a warehouse environment in accordance with one embodiment;

FIG. 2 illustrates a warehouse environment in accordance with another embodiment;

FIGS. 3A & B illustrate a hybrid end effector in accordance with one embodiment;

FIG. 4 depicts an exemplary architecture of a hybrid end effector in accordance with one embodiment;

FIG. 5 depicts an exemplary architecture of the retractable assembly 406 of FIG. 4 in accordance with one embodiment;

FIG. 6 illustrates a retractable assembly in accordance with one embodiment;

FIG. 7 illustrates the retractable assembly of FIG. 6 configured as part of a hybrid end effector in accordance with one embodiment;

FIG. 8 illustrates a retractable assembly in accordance with another embodiment;

FIG. 9 depicts an exemplary architecture of the finger portion assembly 408 of FIG. 4 in accordance with one embodiment;

FIGS. 10A & B illustrate a palm of a hybrid end effector in accordance with one embodiment;

FIGS. 11A & B illustrate a palm of a hybrid end effector in accordance with another embodiment;

FIGS. 12A & B illustrate a palm of a hybrid end effector in accordance with another embodiment;

FIGS. 13A & B illustrate a palm of a hybrid end effector in accordance with another embodiment;

FIGS. 14A & B depict an exemplary architecture of the manifold assembly 410 of FIG. 4 in accordance with one embodiment; and

FIG. 15 depicts a flowchart of a method of performing a picking operation in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

The robotic devices and methods described herein provide a single hybrid gripper or end effector (for simplicity, “end effector”) capable of picking a wide range of items. Specifically, the hybrid end effector uses at least one suction device to obtain an initial grasp on an item and then at least one finger portion to stabilize the item. This enables the increased utilization of a robotic picking solution and reduces the need for an operator to route a limited set of items to a picking station or to manually reconfigure the robotic picking station.

The combination of the two gripper styles complements each other. The suction-based gripper achieves a precise, initial grasp on an item, and then the finger-based portions stabilize the grasp to enable the robotic picking device to move the item. In accordance with various embodiments described herein, the suction device is configured with a linear extension member to extend the suction device relative to the finger portions. This enables the hybrid end effector and, specifically, the suction device to reach into small or narrow spaces, grasp an item (including items with small or limited suction sites and those from densely packed groups), and pull the item back into an improved position to achieve a stable grasp on the item. These embodiments therefore allow one or more suction devices to obtain an initial grasp on an item or, depending on the item(s) to be picked, to act as the primary method of grasping.

Additionally, it is not always possible for a single suction device to handle a full range of different items. Accordingly, it is beneficial to add one or more finger portions to stabilize or grasp items such as heavy or large items. The finger portions can engage the item once the suction device is retracted closer to the finger portions, in which case the finger portions do not need to be actuated. Alternatively, the finger portions may actuate to contact the item.

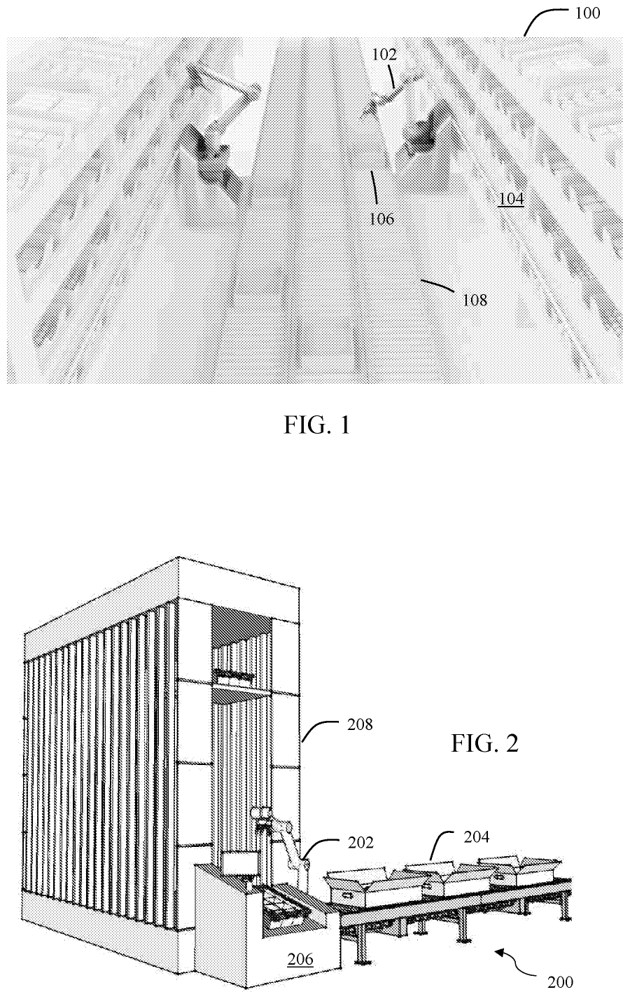

The devices and methods described herein may be implemented in a number of environments and for a number of applications. FIG. 1 illustrates a warehouse environment 100 in which one or more robotic picking devices 102 may be tasked with performing pick-and-place operations. For example, the robotic picking device 102 may comprise an arm portion (e.g. formed of a plurality of arm segments or links) and an end effector and may be tasked with picking an item from a shelving unit 104 and then placing the item in a container 106. The container 106 may be on conveyor belt 108 configured to move the container 106 to and from the robotic picking device 102. Additionally or alternatively, the robotic device 102 may be tasked with picking items from the container 106 and placing the items in a shelving unit 104, put wall, storage location, another bin or container, or the like.

FIG. 2 illustrates another exemplary application in a warehouse environment 200 in which a robotic picking device 202 may be tasked with picking items from one or more containers 204, and placing the items at a loading station 206. These items may then be placed in a shipping container 208 for further shipment, sorting, or processing.

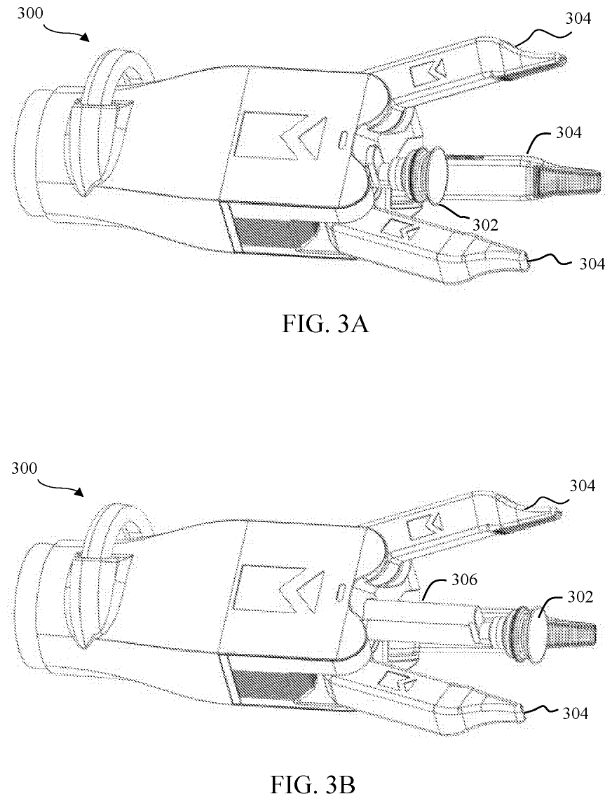

To perform these picking operations, robotic picking devices may be configured with an end effector such as the hybrid end effector 300 shown in FIGS. 3A & B and described above. The end effector 300 in accordance with the embodiments described herein may include one or more suction devices 302 and one or more finger portions 304.

FIG. 3A illustrates the suction device 302 in a retracted position. The suction device 302 may remain in this retracted position until it is needed to obtain an initial grasp on an item to be picked.

At that time, a linear extension member 306 that is operably connected to the suction device 302 may extend as shown in FIG. 3B. That is, the linear extension member 306 may extend to bring the suction device 302 closer to an item to be picked (not shown in FIGS. 3A or B). Although the linear extension member 306 is illustrated in FIG. 3B with two tubular portions, this is only one exemplary embodiment and, as discussed below, the linear extension member 306 may be configured in a variety of ways.

The suction device 302 may be in operable communication with a vacuum system (not shown in FIGS. 3A or B) to generate a suction force. Once in sufficient proximity to the item to be picked, the suction force may enable the suction device 302 to obtain an initial grasp on the item. That is, the suction force may pull the item to be in contact and stay in contact with the suction device 302. The linear extension member 306 may then retract to bring the item closer to the rest of the end effector 300 and, namely, the finger portions 304.

The one or more finger portions 304 may stabilize the item upon or after the suction device 302 obtains the initial grasp on the item. For example, after the linear extension member 306 retracts (with the suction device 302 maintaining its grasp on the item), the one or more finger portions 304 may actuate to contact and therefore stabilize the item. In addition to merely stabilizing the item, the one or more finger portions 304 may ensure a sufficient grasp or level of support on the item to ensure the item does not detach from the suction device 302.

Once the suction device 302 has obtained the initial grasp on the item and one or more finger portions 304 have stabilized the item, the robotic device may maneuver the item and place the item at a designated location. To place the item at a location or to otherwise release the item, the one or more finger portions 304 may, if applicable, actuate to not contact the item, and the suction force may be halted to release the item. Alternatively, the linear extension member 306 may extend to remove the item from contact with the finger portions 304 and suction may be ceased, causing the item to drop.

Extending the suction device 302 relative to the finger portions 304 provides several advantages. For example, it allows the suction device 302 to extend into spaces that are too narrow to accommodate the finger portions 304. It also allows for more angles of approach and allows the spacing between the suction device 302 and the finger portions 304 to be adjusted according to the size, shape, and configuration of the item(s) to be picked.

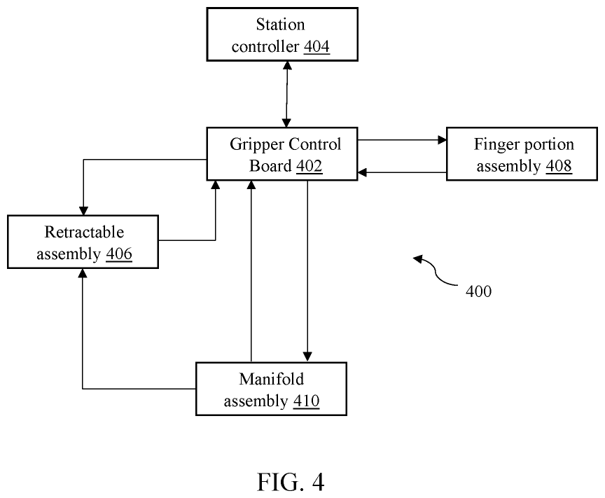

FIG. 4 illustrates an exemplary architecture 400 of a picking device in accordance with one embodiment. The architecture 400 includes a gripper control board 402, a station controller 404, a retractable assembly 406, a finger portion assembly 408, and a manifold assembly 410.

The gripper control board 402 may be configured as any appropriate processing device. The gripper control board 402 may be implemented as software executing on a microprocessor, a field programmable gate array (FPGA), an application-specific integrated circuit (ASIC), or another similar device whether available now or invented hereafter.

Depending on the embodiment, the picking device may have many electronics onboard. These may include a central processing unit to handle communications and any required onboard data processing tasks, drivers to actuate finger portions or other components, and any electronics to process imagery gathered by sensors regarding the picking device's environment and items to be picked.

The station controller 404 may be in operable communication with the gripper control board 402 and may control components related to the picking device's environment. For example, the station controller 404 may issue commands to other external systems such as conveyor belts to move item-storing containers to and from the picking device. The station controller 404 may also issue commands to the picking device and components thereof. For example, the station controller 404 may control whether power is supplied to the picking device.

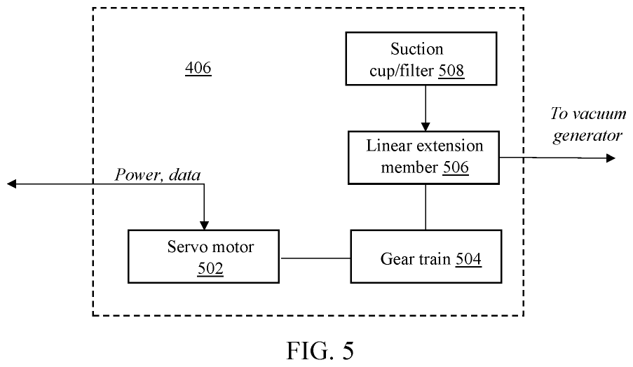

FIG. 5 depicts an exemplary architecture of the retractable assembly 406 of FIG. 4 in accordance with one embodiment. The retractable assembly 406 may be tasked with controlling the motion of the linear extension member such as the linear extension member 306 of FIGS. 3A & B.

As seen in FIG. 5, the retractable assembly 406 may include a servo motor 502 to drive a gear train 504. The servo motor 502 may be an off-the-shelf motor (e.g., Dynamixel XM 430 W210) with a machined frame. The driven gear train 504 may include a series of gears in operable communication with a linear extension member 506 (e.g., the linear extension member 306 of FIGS. 3A & B). As the servo motor 502 and the gear train 504 drive the linear extension member 506, they may also drive the suction cup/filter (for simplicity, “suction device”) 508 by virtue of its connection to the linear extension member 506.

In embodiments reliant on a servo motor 502, any means of converting rotary motion to linear motion may be used. One exemplary technique is the use of rack-and-pinion drives in which a gear rack is attached or machined into the linear extension member 506 and driven by a pinion gear.

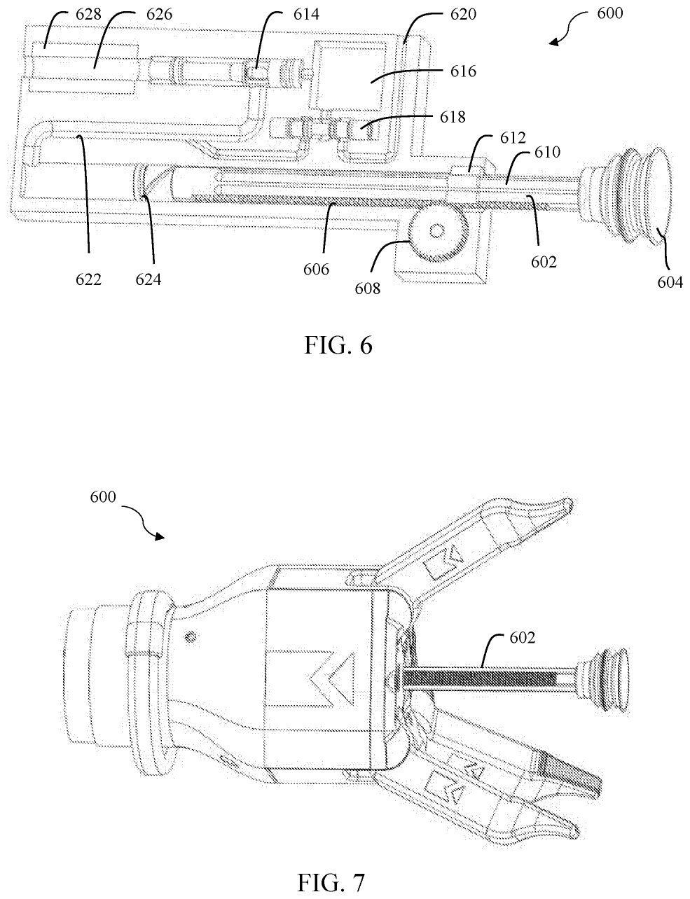

FIG. 6, for example, illustrates a retractable assembly 600 in accordance with one embodiment. The retractable assembly 600 may include a linear extension member 602 in operable connectivity with a suction device 604. In this embodiment, the linear extension member 602 may include a rack 606 that operably engages a drivable pinion 608 to extend and retract. The linear extension member 602 may also include a plurality of fluted portions 610 that engage cylindrical bushings 612 to prevent rotation of the linear extension member 602.

FIG. 6 also illustrates components used to generate the suction force required to obtain the initial grasp on the item in accordance with some embodiments. Although discussed below in greater detail, these components may include a Venturi vacuum generator 614 in operable connectivity with an air reservoir 616. The air reservoir 616 may be in connectivity with a 3-way/2-position valve 618 to a compressed air inlet 620. The Venturi vacuum generator 614 may also be in communication with an air line 622 that extends through the linear extension member 602. The linear extension member 602 may further include or otherwise be in connection with an internal seal 624 to prevent any leakage of the suction force generated by the Venturi vacuum generator 614.

It is noted that the Venturi vacuum generator 614 may generate an undesirable amount of noise. Accordingly, the embodiment shown in FIG. 6 may further include a muffler 626 and a sound absorbing material 628 to reduce the amount of noise produced.

FIG. 7 illustrates a hybrid end effector 700 of a picking device in accordance with another embodiment. The end effector 700 of FIG. 7 may be similar to the end effector 300 of FIGS. 3A & B. However, as seen in FIG. 7, the end effector 700 is configured with the retractable assembly 600 and, more specifically, the linear extension member 602 of FIG. 6.

Other exemplary techniques for controlling the linear extension member 506 may involve a rotating screw that drives a nut fixed to the linear extension member 506 or a rotating nut that drives a screw fixed to the linear extension member 506. In these embodiments, the type of screw used could be any one of the numerous acme, roller, lead, or ball screws that are available for such a purpose.

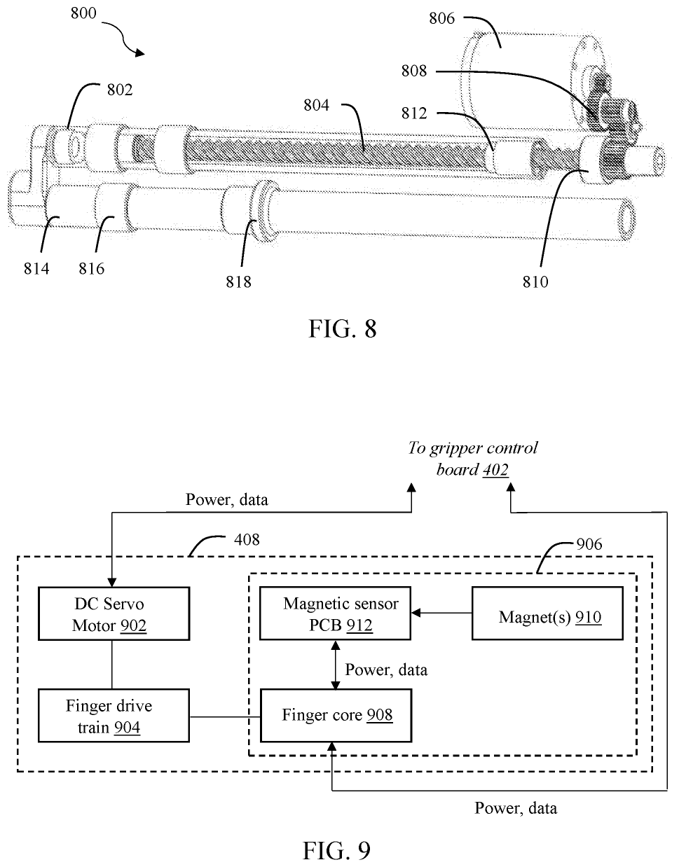

For example, FIG. 8 illustrates a retractable assembly 800 in accordance with another embodiment in which a linear extension member 802 is driven by a lead screw 804 therein. Specifically, a motor 806 may drive a gear train 808 to rotate the lead screw 804. As seen in FIG. 8, the lead screw 804 may be configured with a bearing 810 and a lead nut 812 that, when driven by the gear train 808, causes the liner extension member 802 to extend (or retract).

The retractable assembly 800 also includes an air tube 814 that is parallel to the lead screw 804 to prevent rotation of the linear extension member 802 and also to route air flow through the tube 814 to generate the suction force. The parallel air tube 814 may be configured with one or more guide bushings 816 and an external seal 818 to prevent any leakage of air from the tube 814. Although not shown in FIG. 8, a suction device may be attached to the air tube 814, similar to the configurations of FIGS. 3A & B.

The lead screw 804 is supported from the driven end by bearing 810. This bearing 810 should be designed to support both axial and radial loads. The bearing 810 may be a double row, angular contact ball bearing, for example. The bearing 810 may provide further constraints on the motion of the lead screw 804. The non-driven end of the lead screw 804 is generally unsupported, however, a bushing (not labeled in FIG. 8) may be configured to slide along the inner surface of the linear extension member 802 to provide additional support. This prevents the lead screw 804 from bending, but does not constrain its functional movement.

Accordingly, and referring back to FIG. 5, the motion of the linear extension member 506 (regardless of the embodiment) can be constrained in numerous ways. For example, the linear extension member 506 may be configured with or otherwise include at least one of keyed portions, fluted portions, squared portions, or otherwise configured with a non-circular exterior. The exact configuration of the linear extension member 506 and components thereof may vary as long as the features of the features of the various embodiments may be accomplished.

The suction device 508 may be operably connected to the linear extension member 506 and in further connection with a pneumatic system to generate a suction force on an item of interest. The suction device 508 may be of various sizes and configurations, which may depend on the application or the item(s) to be picked. These may include, but are not limited to, single suction cup configurations, suction cup arrays, foam suction pads, gasket pads, jamming grippers, or any other type of suction-based gripping device whether available now or invented hereafter.

If an array is used, vented air fuses may cut off airflow to sections that do not fully engage the grasped item, thereby allowing other sections of the array to reach optimal pressure. In some embodiments, bellows may be configured with the picking device to compensate for any produced vertical and/or angular misalignment between suction devices and suction sites on the item to be picked.

Although FIG. 5 illustrates a servo motor 502, the retractable assembly 406 may be driven in numerous ways. For example, a pneumatic piston can extend or retract the linear extension member 506 in one direction and use a return spring to provide motion or a force in the other direction. Or, in other embodiments, a dual-acting piston can enable the linear extension member 506 to move in both directions. Another exemplary embodiment may involve the use of belt or chain drivers in which the linear extension member 506 is connected to a tooth or link on a belt or chain that linearly travels between cogs or pulleys.

FIG. 9 depicts an exemplary architecture of the finger portion assembly 408 in accordance with one embodiment. The finger portion assembly 408 may include one or more servo motors 902 configured to drive one or more finger drive trains 904. The servo motor(s) 902 may be off-the-shelf motors (e.g., Dynamixel XM 430 W210) with a machined frame, for example.

The drive train 904 may include a series of gears to transmit torque from the servo motor(s) 902 to the rotational axis of the finger portion(s) of one or more finger assemblies 906. There are many variations on motor and gear designs that could result in higher or lower torques, smaller size, faster finger portion actuation, or other desirable properties. Accordingly, the amount of finger portion deflection may be determined by monitoring torque as well. The exact size or configuration of these components may vary as long as the features of the embodiments described herein may be accomplished.

The one or more finger assemblies 906 may receive power from the drive train 904 at a finger core 908. The finger portions may be formed from solid polyuerthane rubber molded to form a plurality of linkages separated by hinges. These hinges may provide both flexibility and a spring force for compliance as well as for returning the finger portion(s) to a neutral position. The finger core 908 may include wires that pass through a gasket into the center of an axle therein.

In other embodiments, a pneumatic actuator may close or open the finger portion(s) with a return spring to provide motion in the opposite direction. Similarly, a dual-acting pneumatic actuator could be used to drive the finger portion(s) in both directions.

Each finger portion may have magnets 910 embedded in linkages that correspond to Hall effect sensors molded on a magnetic sensor printed circuit board (PCB) 912. In this configuration, deflection of the finger portion(s) cause the magnets 910 to shift relative to the magnetic sensor PCB 912. The resultant signal(s) may help determine how much deflection the associated finger portion is experiencing. Additionally, these signal(s) may provide data regarding the direction of the load.

The finger portions may be configured to be compliant so that they conform to the grasped item when actuated. The grasp can be further improved by shaping the finger portions so that, when actuated, they curve toward the item in a way so as to wrap around the item.

As seen in FIG. 9, data regarding the finger portion(s)' operation may be communicated to the gripper control board 402 of FIG. 4. This data may be communicated to the other components or systems associated with the hybrid end effector 400 as well. For example, data regarding the position of the finger portion(s) may be monitored via an encoder (not shown in FIG. 9) linked directly to one or more finger portions. Or, an encoder may similarly be connected to the motor 902.

If pneumatic actuation is used to actuate the finger portion(s), force on the finger portion(s) may be measured by monitoring pressure. If electric actuation is used, force on the finger portion can be measured by monitoring current. Force on the finger portion(s) (which may be indicative of whether an item is being grasped), can be more precisely determined by measuring the deflection of a series spring or load cell. If the finger portions are compliant, force can be monitored by measuring the deflection of the finger portions themselves.

Feedback about the item and quality of the grasp can be obtained via tactile sensing. Sensors placed in the finger portions themselves can be used to detect whether an item has been contacted, how much pressure is applied to the item, and where on the finger portion the item is contacting. For example, a MEMS barometer may be embedded in a molded rubber core 908 of a finger portion to detect and measure surface pressure. The above-described techniques of measuring or otherwise monitoring deflection of the finger portion(s) are merely exemplary and other techniques, whether available now or invented hereafter, may be used.

Although the end effectors of FIGS. 3A & B and FIG. 7 are illustrated as including three finger portions, the hybrid end effectors in accordance with various embodiments described herein may include more than or less than three finger portions. For example, and as discussed below, an end effector may include only two finger portions (e.g., positioned on opposite sides of the suction device) that “pinch” the item once the suction device obtains the initial grasp on the item.

Or, in some embodiments, the end effector may only include one finger portion. In this case, the single finger portion may be operably positioned below the suction device such that an item rests on the single finger portion when grasped by the suction device. This lessens the likelihood that gravity will cause the item to detach from the suction device.

In other embodiments, the hybrid end effector may include more than three finger portions. In fact, the number of finger portions is only limited by size, power, and cost restraints. Accordingly, the number, size, and configuration of the finger portions may vary as long as the features of the various embodiments of the devices and methods described herein may be accomplished.

If three or more finger portions are used, they can be arranged symmetrically or asymmetrically around the item to support the item from multiple sides. It may be beneficial to arrange finger portions into opposing groups such that long, slender items can be grasped. In some embodiments, it may be beneficial to offset one or more of the finger portions so they do not intersect each other.

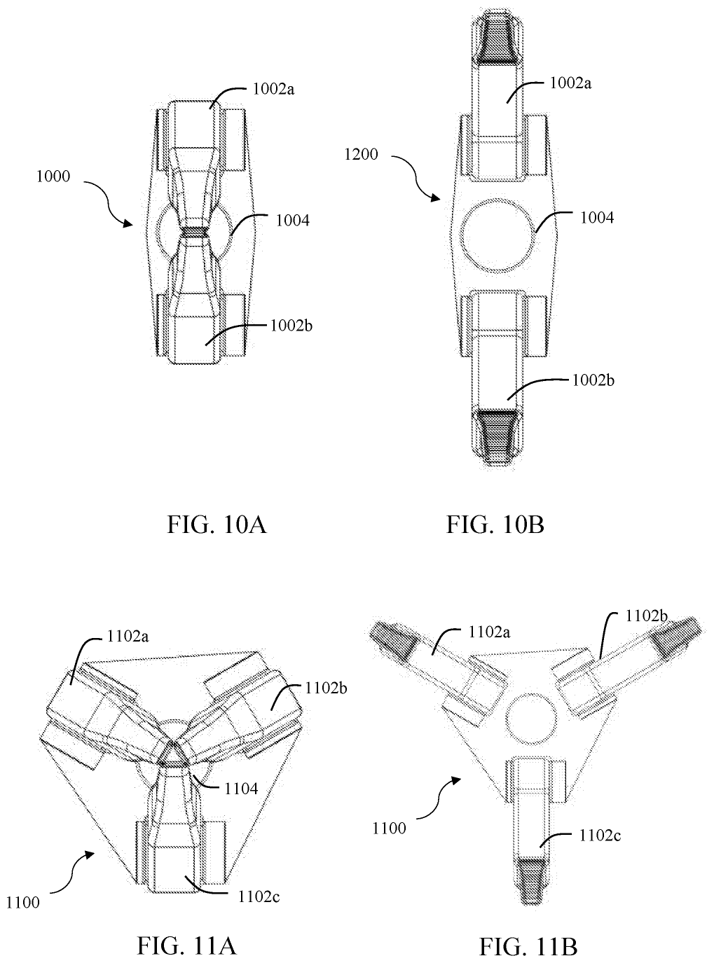

FIGS. 10A & B illustrate front views a palm 1000 of a hybrid end effector in accordance with one embodiment. In this embodiment, the palm 1000 includes two finger portions 1002a-b that are opposed to each other opposite a suction device 1004. Specifically, FIG. 10A illustrates the finger portions 1002a-b in a “closed” position in which they are actuated to close on and contact an item (not shown in FIGS. 10A & B). Although FIG. 10A illustrates the finger portions 1002a-b contacting each other, they likely will not contact each other directly in the closed position during the operation as they would likely be contacting a grasped item therebetween.

FIG. 10B, on the other hand, illustrates the finger portions 1002a-b in an “open” position. The finger portions 1002a-b may be in the open position before grasping an item and to release an item.

FIGS. 11A & B illustrate front views of a palm 1100 of a hybrid end effector in accordance with another embodiment. In this embodiment, the palm 1100 includes three finger portions 1102a-c that are positioned about a suction device 1104. Specifically, FIG. 11A illustrates the finger portions 1102a-c in a “closed” position in which they are actuated to close on and contact an item (not shown in FIGS. 11A & B). Although FIG. 11A illustrates the finger portions 1102a-c contacting each other, they likely will not contact each other directly in the closed position during operation as they would likely be contacting a grasped item therebetween.

FIG. 11B, on the other hand, illustrates the finger portions 1102a-c in an “open position. The finger portions 1102a-c may be in the open position before grasping an item and to release an item.

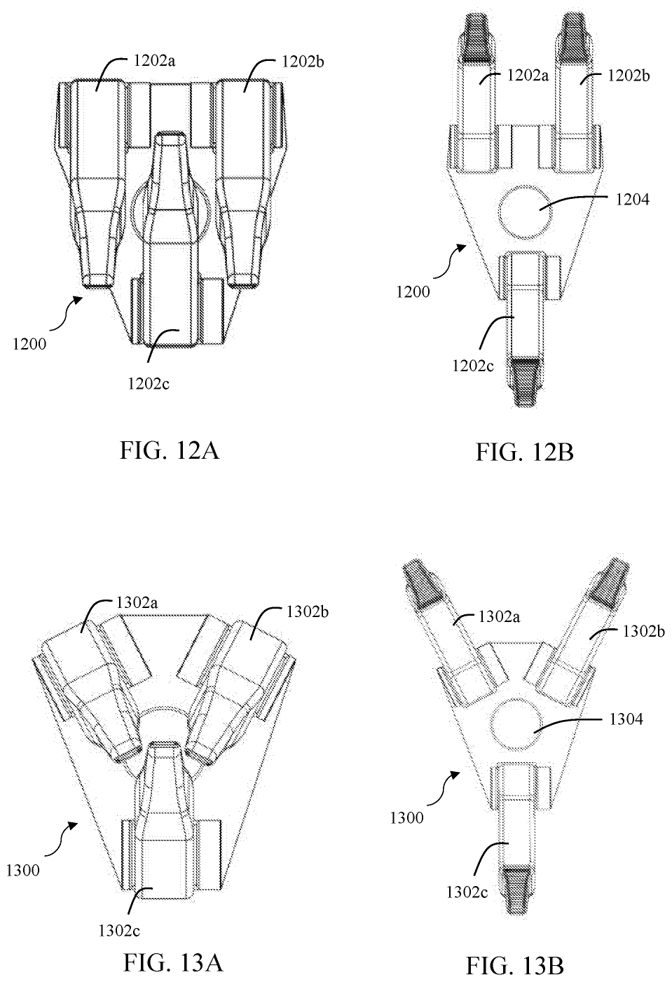

FIGS. 12A & B illustrate front views of a palm 1200 of a hybrid end effector in accordance with another embodiment. In this embodiment, the palm 1200 includes three finger portions 1202a-c that are positioned about a suction device 1204. Specifically, FIG. 12A illustrates the finger portions 1202a-c in a “closed” position in which they are actuated to close on and contact an item (not shown in FIGS. 12A & B).

As opposed to FIGS. 11A & B, however, the finger portions 1202a-c are not positioned at equal distances from each other. Rather, finger portions 1202a and 1202b are parallel with each other and are positioned on opposite sides of the suction device 1204 from the finger portion 1202c. Accordingly, the finger portions 1202a-c will not intersect with or otherwise contact each other during actuation.

FIG. 12B illustrates the finger portions 1202a-c in an “open” position. The finger portions 1202a-c may be in the open position before grasping an item and to release an item.

FIGS. 13A & B illustrate front views of a palm 1300 of a hybrid end effector in accordance with another embodiment. In this embodiment, the palm 1300 includes three finger portions 1302a-c that are positioned about a suction device 1304. Specifically, FIG. 13A illustrates the finger portions 1302a-c in a “closed” position in which they are actuated to close on and contact an item (not shown in FIGS. 13A & B).

As opposed to FIGS. 11A & B, however, the finger portions 1302a-c are not positioned at equal distances from each other. Rather, finger portions 1302a and 1302b are positioned on opposite sides of the suction device 1304 from the finger portion 1302c. Accordingly, the finger portions 1302a-c will not intersect with or otherwise contact each other during actuation. Unlike the configuration of FIGS. 12A & B, however, finger portions 1302a and 1302b are not parallel with each other.

FIG. 13B illustrates the finger portions 1302a-c in an “open” position. The finger portions 1302a-c may be in the open position before grasping an item and to release an item

In some embodiments, the finger portion(s) may be static in that they are not actuated to stabilize the item. For example, a grasped item may come to rest on a single, static finger portion as discussed above. In these embodiments, the above-described components associated with the finger portion assembly 408 such as the servo motors 902 and gear train 904 would not be necessary.

The finger portions may be actuated to contact the grasped item(s) in a variety of ways. For example, the finger portions may move linearly, rotate around a base, or be curled in via a tendon or linkage train. The type of actuation techniques used may vary as long as the features of the various embodiments described herein may be accomplished.

Referring back to FIG. 4, the manifold assembly 410 may be tasked with providing the suction force to obtain the initial grasp on an item of interest. In order for the suction device(s) described herein to perform their required functions, air must be routed to the end of the linear extension member. Exemplary configurations to achieve the required air routing may include sliding seal(s), flexible tubes, bellows tubes, or the like. Sliding seals can be internal (e.g., as with seal 624 of FIG. 6) and include an o-ring or a wiper that slides inside a tube or can be external (as with seal 818 of FIG. 8) with an o-ring or wiper that slides on the outside of a shaft. In both configurations, the seal may need to tolerate any debris or contamination that may be inadvertently gathered by the suction device(s).

Similarly, bellows or flexible tubes (if used) must be able to shed or otherwise avoid collecting debris. These components must also be supported to prevent kinking or other types of misalignment.

In embodiments that use sliding seals or bellows, the actuation technique or configuration used must be rated to support any linear force generated by the air pressure difference once the suction device(s) are engaged. In the case that the linear extension member retracts after obtaining the initial grasp on an item, and vacuum pressure is applied across the linear extension member, the resultant pressure difference may help with this motion.

The sliding seals can be made in a number of ways. They must be somewhat flexible to minimize clearance between the seal and the surface on which it slides and thus minimize leakage. In some embodiments, this seal may be formed of flexible rubber such as an o-ring that is compressed between the sliding surface and a groove to maintain contact. In some embodiments, the seal can be made of a flexible material in which a flange is formed. In this case, hoop stress or bending stress will maintain this contact.

In some embodiments, the seal can be comprised of a flexible strip or piston ring that wraps a majority of the way around the sliding surface, but also has a gap between its ends thereby allowing it to flex. In this case, bending stress can be used to maintain initial contact between the seal and the sliding surface. Once pressure is applied, the pressure difference can be used to add to the force holding the seal in place. Such split-ring seals can be made of more rigid material than compressed or flange-based seals. However, they will always have some minor leakage through the split in the ring. Regardless of the construction of the seal, it may be beneficial to have sharp leading edges to help catch and scrape off any debris that adheres to the sliding surface.

The suction force may be generated in a variety of ways including, but not limited to, pumps, blowers, Venturi vacuum generators, or the like. These devices may be located separate from the picking device with the air being routed via flexible tubes, or within the picking device with air being routed to the suction device via a channel within the linear extension member or at the end of the linear extension member through a connection directly to the suction device(s) as discussed previously. For example, a Venturi vacuum generator may be machined into or otherwise integrated with the end effector.

There may be several tradeoffs to consider in selecting the position of the vacuum generator. The further from the suction device it is placed, the larger the air volume between the vacuum generator and the suction device becomes. This slows down the rate at which the suction device can be engaged or disengaged, and may require the use of a more powerful vacuum generator. However, vacuum generators tend to be moderately large, especially if a muffler is used. Accordingly, it may be necessary to move the vacuum generator(s) away from the suction device if the suction device is required to fit into tight spaces.

Regardless of which method is used to generate the suction force, care should be taken to avoid damaging or clogging the suction-generating device with debris. To achieve this, a filter can be placed between the suction device and the device used to generate the suction force.

Regardless of which method is used to generate the suction force, exhaust must be vented to atmosphere. If the vacuum generator is loud, it may be desirable to muffle or otherwise damp the produced noise as discussed above. This can be achieved by forcing the air to pass through a sound absorbing material (as with 628 of FIG. 6) such as felt, foam, or sintered plastic once it leaves the vacuum generator. If air passes directly through this material, the material may clog with debris over time. To avoid this a tunnel can be run through the sound-absorbing material as with muffler 626 of FIG. 6).

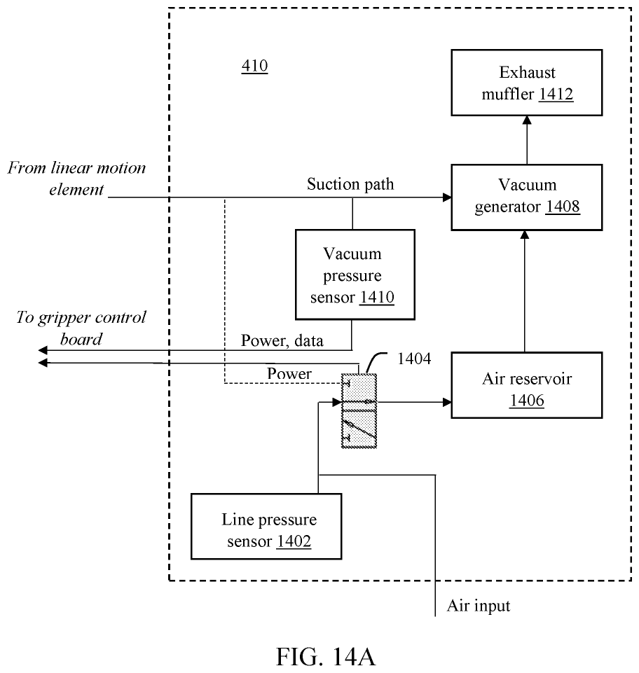

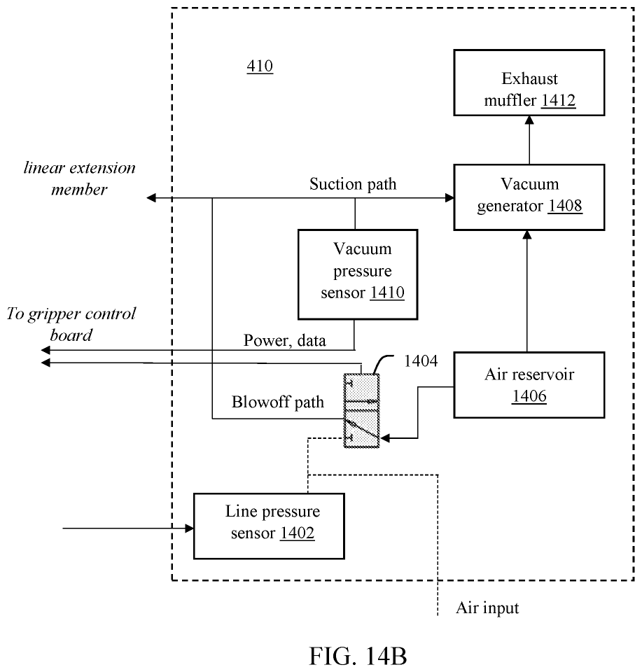

FIGS. 14A &B depict an exemplary architecture of the manifold assembly 410 of FIG. 4 in more detail. Specifically, FIG. 14A illustrates the manifold assembly 410 during a suction phase in accordance with one embodiment. Compressed air (e.g., at 100 PSI) may enter the manifold assembly 410 at the base of the end effector assembly, where the line pressure may be measured by a line pressure sensor 1402. The line pressure sensor 1402 may be in operable communication with the gripper control board 402 to receive power from and to communicate data therewith.

During the suction phase, the compressed air may pass through a 3-way/2-position valve 1404 to an air reservoir 1406 at high pressure. The air may be directed from the reservoir 1406 to a single stage, Venturi vacuum generator cartridge 1408, which in turns draws in air through the suction device 508 of the retractable suction assembly 406 (see FIG. 5). The Venturi vacuum generator cartridge 1408 may be onboard with the robotic picking device or at a location separate from the robotic picking device. Similarly, any other required blowers and/or pumps may be operably connected to the robotic device, even if separated from the robotic picking device.

As seen in FIG. 14A, a vacuum pressure sensor 1410 may measure the pressure in the vacuum line (e.g., to determine whether the suction device 508 has obtained an initial grasp on an item). Pressurized air may exit the end effector assembly through an exhaust muffler 1412.

When the vacuum generator cartridge 1408 is disabled, the air volume between it and the suction device will still be low. Depending on how large this volume is and how much, if at all, the suction device or vacuum generator leaks, the suction device may take an undesirably long time to fully disengage from the picked item.

It may therefore be beneficial to add air to the volume between the vacuum generator and the suction device. This could be done by opening a valve to the atmosphere or to a source of compressed air. If compressed air is used, this may further help keep the suction device clear of debris.

If a Venturi vacuum generator is used (as in FIG. 14A), there will be some volume of compressed air between the valve that controls the generator and the associated nozzle. If a 3-way valve is used, the volume of air can be used to provide an exhaust force without the need for additional valves by connecting the exhaust port to the volume between the vacuum generator and suction device. However, care should be taken to prevent debris being picked up by the suction device from contaminating the valve. This can be done with filters or with a labyrinth as air will only ever travel away from this port of the valve.

FIG. 14B illustrates the manifold assembly 410 during an exhaust phase in accordance with one embodiment. As seen in FIG. 14B, the valve 1404 has switched position to (1) cut off compressed air from the air input, and (2) direct air from the air reservoir 1406 to the linear extension member 506 of FIG. 5 (not shown in FIG. 14B). That is, the reservoir 1406 vents directly into the vacuum line to the linear extension member 506. This quickly releases the vacuum and blows a puff of pressurized air out of the suction device 508. Not only does this release the item, but it also keeps the vacuum lines clean.

During exhaust, some air from the reservoir 1406 also exits the exhaust muffler 1412. Internal constrictions of the manifold assembly 410 may control how much air flows through each path. For example, the manifold assembly 410 may be machined to optimize the exhaust force to keep the system clean but also without damaging items by ejecting them too quickly. Similarly, the strength of the exhaust force may be chosen to increase the overall rate or range of item placements.

Data regarding the suction components and their operation may be gathered in a number of ways. Tactile sensors or deflection sensors mounted on the suction device can provide information about the grasped item or quality of the grasp. A measure of the air pressure in the line between the vacuum generator and suction device can be used to determine if the suction device is engaged with an item. Vacuum level can also be used to evaluate the quality of that grasp. If the suction device is engaged with a known item, the vacuum level can be used to check for damage to the suction device. If the vacuum generator is on and the suction device is not engaged with anything, the measured vacuum level can be used to check for clogs in the suction device or any filter used.

The manifold assembly 410 may be formed from aluminum and may hold the required linear extension member, pneumatics, and electronics. Air routing may accomplished via face milled slots, for example.

Regarding connections throughout the hybrid end effector, a pigtail cable may be fixed to the hybrid end effector via a strain relief boot on one end that has both a connector for high pressure air and an electrical connector that handles both data and power connections to the gripper control board 402 to receive commands. These connections may plug into a cable harness mounted to an arm of a robotic picking device. The arm holding the hybrid end effector may include a service loop to allow full rotation of any wrist or arm joints of the robotic picking device without tangling or stressing the cables during picking.

A logo or some other indicia may be printed on the sides of the hybrid end effector outer shell for calibration. The logo may have a known size and shape that is repeatable and allows for the automatic calibration of the relative position(s) between the imaging sensors, the arm frame of reference, and the position of the relevant features on the hybrid end effector. This calibration may be achieved by moving the logo through a number of points in the sensors' field of view and registering the observed position of the logo to the expected position based on the arm frame of reference. The calibration procedure also allows for the compensation of non-linearities in the sensor output (using e.g., both depth and RBG images).

Along with the feedback obtained directly through the elements in a given embodiment, additional sensor devices can be used to help locate items to be picked, obtain information about an item already grasped, or the like. Depending on which of these elements a particular embodiment uses, the picking device may have significant onboard electronics as discussed above. The picking device may also include or otherwise rely on sensors such as, but not limited to, black and white cameras, visible light cameras, color cameras, infrared cameras, stereoscopic depth cameras, dot projector depth cameras, ultrasonic range finders, time-of-flight range finders, time-of-flight depth cameras, and tactile sensors mounted on the picking device.

Any suitable image processing techniques may be used to analyze the received imagery. Additionally, this imagery analysis may be used to plan an appropriate path for which the picking device is to follow in order to perform its picking tasks.

A picking device may often inadvertently apply pressure to its workspace when reaching for an item therein. This can happen for a number of reasons such as by overshooting the item due to incorrectly estimating the position of the item, deliberately overshooting the item to help the suction device obtain a sufficient seal on the item, by pressing the finger portion(s) down between packed items, or by inadvertently crashing into an item or structure. It may therefore be beneficial to have some compliance in the picking device to prevent damage to the items or the picking device itself. Accordingly, in some embodiments, a suspension mechanism may be added between the picking device and the arm or other apparatus to which the picking device is mounted. As the picking device almost always enters its workspace traveling in the same direction, this suspension may be a linear suspension mechanism.

A spring can be added to the suspension mechanism to keep the picking device in an extended position to prevent any inadvertent movement. To prevent shock loads in the case that the picking device crashes and the full force of the suspension mechanism is used, a nonlinear spring or damper can be installed as well. In addition to or in lieu of providing a dampening effect, these types of suspension mechanisms may also help center or otherwise align the picking device in a certain position or orientation.

Measuring the position of the suspension can provide feedback about the state of the robotic picking device. This information can include, but is not limited to, how hard the finger portions are pressing into an item or group of items, whether the picking device has crashed and with what amount of force, etc. If the picking device includes a dual-acting spring such that the unloaded gripper “floats” in the middle of the suspension, measuring displacement can provide feedback about the weight of any items the gripper is holding as well.

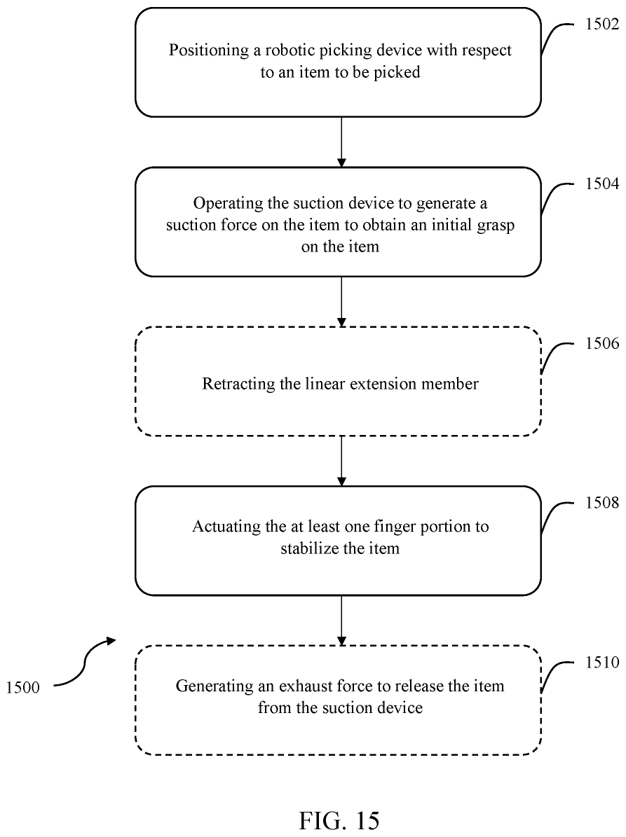

FIG. 15 depicts a flowchart of a method 1500 of performing a picking operation in accordance with one embodiment. The hybrid end effector of FIG. 4 or components thereof may perform the steps of method 1500.

Step 1502 involves positioning a robotic picking device with respect to an item to be picked, wherein the robotic picking device includes a suction device and at least one finger portion. The robotic picking device may be tasked with performing pick-and-place operations in environments such as those shown in FIG. 1 or 2. Accordingly, step 1502 involves positioning the picking device at a location such that it can access or otherwise pick the item of interest. This step may involve, for example, actuating a linear extension member such as the linear extension member 506 of FIG. 5 to position the suction device closer to the item.

Step 1504 involves operating the suction device to generate a suction force on the item to obtain an initial grasp on the item. The robotic picking device may be positioned close enough to the item of interest such that the generated suction force enables the suction device to obtain the initial grasp on the item.

Step 1506 involves retracting the linear extension member after the suction device has obtained the initial grasp on the item. Once the suction device has obtained the initial grasp on the item (e.g., as determined by a change in pressure measured by a pressure sensor such as the vacuum pressure sensor 1410 of FIG. 14A), the linear extension member may retract to bring the suction device closer to the end effector and, namely, finger portions.

Step 1508 involves actuating the at least one finger portion to stabilize the item. The suction device obtains the initial grasp on the item. Once the suction device obtains the initial grasp on the item, the robotic picking device may need to move the item to another location. This movement, however, may cause the item to detach from the suction device (e.g., if the generated suction force is not strong enough).

Accordingly, the robotic picking device may actuate at least one finger portion to stabilize the item to provide further support. For example, the robotic picking device may include at least one finger portion that is actuated to contact the item (e.g., to “close” around the item).

In some embodiments, the robotic picking device may only include one finger portion. In this case, the single finger portion may be positioned below the suction device such that the item rests on the finger portion once initially grasped by the suction device. In these embodiments, the finger portion may be actuated to contact the item or may be static such that the item is pulled onto and rests on the finger portion.

Step 1510 involves generating an exhaust force to release the item from the suction device. Once the robotic picking device has operably positioned the item near its “place” location, the robotic picking device may actuate a valve to direct air to generate a “puff” force to release the item from the suction device. The item may then fall into its destination, such as a bin or other location for further processing or shipment.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

1. A method of performing a picking operation, the method comprising:
positioning a robotic picking device with respect to an item to be picked, wherein the robotic picking device includes a suction device and at least one finger portion;
operating the suction device to generate a suction force on the item to obtain an initial grasp on the item; and
actuating the at least one finger portion to stabilize the item.

2. The method of claim 1 wherein the suction device is operably connected to a linear extension member, and the method further includes extending the linear extension member to at least assist in obtaining the initial grasp on the item.

3. The method of claim 2 further comprising retracting the linear extension member after the suction device has obtained the initial grasp on the item.

4.-6. (canceled)

7. The method of claim 1 wherein actuating the at least one finger portion to stabilize the item includes closing at least three finger portions to contact the item to stabilize the item.

8. The method of claim 7 wherein the at least three finger portions are positioned about the suction device.

9. The method of claim 8 wherein each of the at least three finger portions are positioned to not intersect with each other when the finger portions are actuated.

10. The method of claim 1 wherein the at least one finger portion is actuated to stabilize the item after the suction device has obtained the initial grasp on the item.

11. The method of claim 1 wherein operating the suction device includes routing air flow through milled slots in a manifold assembly in operable connectivity with the suction device.

12. The method of claim 1 further comprising generating an exhaust force to release the item from the suction device.

13. A robotic picking device for performing a picking operation, the robotic picking device comprising:
a suction device configured to generate a suction force on an item to be picked to obtain an initial grasp on the item; and
at least one finger portion configured to stabilize the item upon the suction device obtaining the initial grasp on the item.

14. The picking device of claim 13 further comprising a linear extension member configured to extend the suction device to at least assist in obtaining the initial grasp on the item, wherein the linear extension member is driven by a lead screw in operable connectivity with the suction device.

15. The picking device of claim 14 further comprising a bearing at a driven end of the lead screw to at least partially constrain the lead screw's motion.

16. The picking device of claim 11 further comprising:
a tube portion housing the lead screw, and
at least one bushing configured to at least partially constrain the lead screw's motion.

17. The picking device of claim 13 further comprising a split-ring seal configured to slide along the tube portion.

18. The picking device of claim 14 wherein the linear extension member is further configured to be retracted after the suction device has obtained the initial grasp on the item.

19. The picking device of claim 14 wherein the linear extension member is driven by a motor and includes a vacuum line therein.

20. The picking device of claim 19 wherein the linear extension member is configured with at least one of fluted portions, keyed portions, squared portions, and a non-circular exterior to prevent rotation of the linear extension member.

21. The picking device of claim 19 further comprising a sliding seal configured with the linear extension member to prevent leakage of the suction force.

22. The picking device of claim 13 wherein the at least one finger portion includes three finger portions to contact the item to stabilize the item, wherein the finger portions are positioned about the suction device, and each of the finger portions are positioned to not intersect with each other when the finger portions are actuated.

23. The picking device of claim 13 further comprising a manifold assembly, wherein the generated suction force is routed through milled slots in the manifold assembly.

24. (canceled)
